(19) United States
(12) Patent Application Publication
(10) Pub. No.: US 2023/0268813 A1
(43) Pub. Date: Aug. 24, 2023

(54) APPARATUS AND METHOD FOR DEFORMING THE CONDUCTORS OF AT LEAST ONE WINDING ASSEMBLY, PROTRUDING FROM A SIDE OF A STATOR OR ROTOR OF AN ELECTRIC MACHINE

(71) Applicant: TECNOMATIC SPA, CORROPOLI (Teramo) (IT)

(72) Inventors: Sergio TANCREDI, CORROPOLI (Teramo) (IT); Giovanni RUGGIERI, CORROPOLI (Teramo) (IT); Giuseppe RANALLI, CORROPOLI (Teramo) (IT); Maurilio MICUCCI, CORROPOLI (Teramo) (IT)

(21) Appl. No.: 18/006,356

(22) PCT Filed: Oct. 29, 2021
(86) PCT No.: PCT/IB2021/060018

§ 371 Date: Jan. 20, 2023

(30) Foreign Application Priority Data
Dec. 15, 2020 (IT) 102020000030824

(51) Int. Cl. H02K 15/00; B21F 3/02

(52) U.S. Cl. CPC H02K 15/0087; B21F 3/02

(57) ABSTRACT

An apparatus for deforming conductors of at least one winding assembly protruding from a side of a stator or rotor of an electric machine is provided. The conductors are arranged with at least one leg inserted into cavities of the stator or rotor, having at least one free end. The apparatus has at least one twisting matrix rotating about an axis and having at least one pocket for insertion of the at least one free end, a radial backing member provided close to the at least one twisting matrix, and in particular close to the at least one pocket on an insertion side of the at least one free end. The radial backing member has an inner radial backing surface for a portion of the at least one leg protruding from the side of the stator or rotor.

### FIELD OF APPLICATION

The present invention relates to an apparatus and method for deforming conductors protruding from a side of a stator or of a rotor of an electric machine. In particular, the present invention relates to the method of twisting conductor ends on the welding side.

### BACKGROUND ART

It is known to create winding sets of electric rod conductors for stators or rotors of electric machines, such as generators or electric motors.

In this type of winding, the electric rod conductors form an element of the winding, which is shaped in a sequence of steps, and inserted together with others into a stator or rotor so that the ends of such elements can be welded together to form a predetermined winding pattern, also referred to as an electric rod winding.

A particular type of electric rod conductors is often referred to as “hairpins” in technical jargon, because of their initial shape. Hereafter, we will use the term “hairpin” for simplicity.

The hairpins, which comprise two legs or ends which will also be indicated by the term terminals below, are assembled on a stator or a rotor of an electric machine to form a circular set, which is generally defined by the term “winding set”. Therefore, a rod winding may comprise one or more mutually concentric sets, in which the hairpins are electrically connected to one another according to a predetermined pattern, according to the type of operation required.

A stator or rotor core of an electric machine with radial magnetic flux substantially is a ring having two flat faces and two cylindrical surfaces, having generators perpendicular to the two flat faces parallel to the rotation axis of the rotor of the electric machine. The radial, circumferential and axial directions hereinafter refer to the latter axis, unless otherwise specified. One of the two cylindrical surfaces is adjacent, at least partially, to the air gap of the electric machine, to which said stator or rotor belong and defines a group of grooves in which the straight parts of the winding are housed. The two flat surfaces are divided into insertion surface or side and the surface or side opposite to the insertion side, also referred to as the twisting side. The parts of the winding which protrude from the core are referred to as headers. The ends of the free portions of the conductors belong to the header protruding from the side opposite to the insertion header, most of which are subjected to twisting after insertion and welding. If protruding portions connected in a bridge-like manner are present in the winding, they belong to the header protruding from the insertion side. The portions protruding from the insertion side, either free or connected in a bridge-like manner, are indicated hereafter as portions from the insertion side.

The stator or rotor core region between a groove and an adjacent one is referred to as a tooth. The number of teeth is equal to the number of grooves. The connecting part of the teeth of the core, which also defines a portion of each groove and is located with respect thereto on the side opposite to the groove opening on the air gap of the machine, is referred to as a yoke.

The groove can be divided into a matrix of positions in each of which a leg of a rod conductor can be placed. The conductors housed in the same radial position of the grooves define a so-called winding layer.

In other words, the term “layer” indicates an annular array of terminals or legs; each set comprises two layers, an inner layer, and an outer layer.

As for the cross-section of the hairpins, it may be circular, rectangular, or square, for example. In particular, a rectangular or square section means a substantially rectangular or square section having rounded edges. There are also other types of cross-sections, e.g. trapezoidal-shaped, in which the edges, as in the previous rectangular section, are rounded. The cross-sections of the hairpins are known per se to a those in the art, which is the reason why they will not be described further.

A known hairpin forming process essentially involves three main steps: a pre-forming, an insertion-side twisting (or pre-insertion twisting), and a welding-side twisting (or post-insertion twisting).

Pre-forming involves the initial bending of a straight rod, by means of which a “U-” or “P-” shape is obtained. An example of forming method and respective equipment is described in United States Patent U.S. Pat. No. 7,480,987.

In this first step, the hairpin comprises two legs side-by-side, connected at one end, which may have the same length (“U”-shape) or different length (“P”-shape). Indeed, this preforming provides a winding element resembling a hairpin is obtained, a term later extended to conductors with non-adjacent legs. Each leg of the hairpin thus has a free end, opposite to the connected end. Each free end is provided with an end face which results from the cutting of the conductor used to form the hairpin and therefore is substantially a face transversal to the conductor itself.

An example of a pre-formed hairpin is shown in FIG. 1, in which a flattened U-shaped hairpin 102 is shown, having two legs 104, 106, and a connecting portion 112.

The pre-formed hairpin is then subjected to the so-called twisting from the insertion side, a step through which the legs of the hairpin are substantially spread relative to each other. In this regard, a twisting device from the insertion side is used, which provides concentric rollers, which can mutually rotate. Pockets or cavities having a substantially parallel extension to the rotation axis of the rollers, in which the legs of the hairpins can be inserted, are provided on each guide roller. The hairpin is inserted with one leg into a cavity of a first roller and with the other leg into the cavity of a second roller adjacent to the radial direction.

The relative rotation between the two concentric rollers causes a spreading of the connecting portion, which will be substantially equal to the angular distance between the two stator or rotor grooves which house the hairpin when it is mounted to said stator or rotor of an electric machine.

FIG. 2 shows an example of a configuration of a hairpin after twisting from the insertion side. In the figure, it is worth noting that the connection portion 112 has at its top a zone in which the cross-section of the conductor is subjected to a 180° rotation with respect to the medial surface of the hairpin (surface which passes inside the hairpin and includes the two legs).

As the twisting method on the insertion side is known per se to those skilled in the art (e.g. from the U.S. Pat. No. 7,805,825), and since is not the specific object of the present disclosure, it will not be described further.

The twisting from the insertion side is applied to create a winding assembly before it is inserted into a stator.

The hairpin may also be obtained by molding, i.e. from a straight conductor pressed against a contrast of a “punch die” type system. The cross-section of a molded hairpin does not substantially rotate with respect to the median surface of the hairpin.

There are other types of hairpins in the prior art: the so-called “I-pins”, conductors having W shape (“W-shaped conductors”) and stranded hairpins (“stranded”).

As for the I-pin type hairpins, they are hairpins obtained without U-bending, and thus “I”-shaped, as it can be also inferred from the name, or substantially “I”-shaped. Therefore, this type of conductor has two leg portions protruding from different sides of the rotor or stator of an electrical machine.

Hereinafter, in the present disclosure, the base conductor is the conductor which is ready to be inserted into a rotor or stator.

The winding assembly may comprise, for example, a group of base conductors, which have the connecting portions on one side and the legs on the other side, in particular the free ends, mutually parallel so that they can be inserted, for example, into corresponding grooves in a stator core. In other configurations, there may be a winding which does not have connecting portions, e.g., in case of I-pins, or there may be windings with connecting portions and free ends on the same side.

Typically, the free ends of the legs of the base conductors protruding, for example, from the stator core are subjected to twisting, of a different type as compared to the preceding one, referred to as “twisting from welding side” or “post-insertion twisting” performed with a corresponding device. FIG. 3 shows an example of a base conductor after having been subjected to a twisting method on the welding side.

The main purpose of the twisting is to bring together two free ends of legs, initially on different circumferences but on two radial directions mutually spaced apart.

The approach between the ends is, for example, achieved by inserting each layer of free ends of the legs of the base elements into respective seats or grooves of a twisting ring dedicated to such a layer. The mutually concentric twisting rings, by rotating one against the other, determine such an approach of the ends.

For example, by using as unit for the distance between the in-groove housed portions of two ends to be approached, the number of grooves between said portions, assuming a distance of six grooves, the approach can be achieved by rotating three grooves one of the rings in one direction and the three grooves of the other ring in the opposite direction.

Thus, the base conductors comprise a first leg portion which remains within the corresponding groove, e.g. of the stator, a portion inclined with respect to the main axis of the stator core, in the rotation direction of the respective ring, and an end substantially parallel to the main axis of the stator core, but in a different radial direction with respect to the first leg portion.

An example of a method and a twisting device on the welding side is described, for example, in U.S. Pat. No. 8,215,000. In particular, a twisting device is described which allows obtaining a differentiated twisting of the ends inserted into the same ring. The differentiated twisting is achieved, for example, by providing that a ring portion, comprising a groove, is movable along the circumference of the ring itself. The mobility implies that, once the ring has been rotated, the end of the base conductor inserted into the groove of the movable ring has a delay in twisting, until the movable portion abuts on the remaining part of the ring structure.

However, the method of welding the ends of the base conductors is a very delicate step of the process by means of which the rod windings are obtained, since they are very close to one another.

Indeed, although the proximity of the ends of the base elements is a desired feature, it is often a complication of the welding process. For example, if the welding must take place only between two ends, this step must be very precise to prevent involving the immediately contiguous ends.

Furthermore, due to the proximity of the ends, electrical phenomena, such as electric arcs between pairs of terminals, are possible, albeit in isolated cases.

Again, using a twisting device according to the prior art, if the number of conductors housed in each stator (or rotor) groove is high, there is a misalignment between the conductors which are close to one another and the respective cavities of the twisting device which instead are separated by radially spaced walls.

Furthermore, the radial proximity between the legs prevents the insertion of insulating rings between layers of the same set.

To overcome these drawbacks, it is known to use twisting rings comprising at least one pocket element movable according to a radial direction either towards or away from the axis of the twisting ring itself. An apparatus of this type is shown in WO2020058842A1.

In this type of apparatus, pocket elements related to the same layer of conductors which are movable in the radial direction are arranged.

In other words, a typical operation of this apparatus provides a step of spreading a layer of conductors before and/or during the actual step of twisting.

Such a method, in order to be effective, must ensure precise guidance of the conductor, of the portion inserted into the pocket but also of the portion of the conductor which is not inserted into the pocket and immediately outside it.

Thus, the prior art although widely used and appreciated is not free from drawbacks.

Indeed, it lacks a guidance system which allows the portion of conductors outside the pocket to maintain a given position during the deformations to which it is subjected.

### PRESENTATION OF THE INVENTION

The need is thus felt to solve at least partially the drawbacks and limitations mentioned above with reference to the prior art.

Therefore, the need is felt to provide an apparatus and method which will allow the free ends of the conductors to be guided more accurately during the steps of bending.

Furthermore, the need is felt to provide an apparatus and method which allow decreasing the stresses located on the end of the conductor which may affect the integrity of the surface coating of the conductors.

Moreover, the need is felt for an apparatus which allows keeping some or all of the conductors subjected to twisting outside a circle of predetermined dimensions, when seen from the stator axis, during and following their deformation. For example, in a particular case, the circle at issue lies in a plane perpendicular to the apparatus axis or stator axis and is identified as substantially tangent to the inner faces of said conductors subjected to twisting in their in-groove position. This is to avoid the risk of bent conductors creating an obstacle to the completion of the insertion of conductors of adjacent layers and/or to reduce the stress on the insulation between the conductors to be twisted belonging to adjacent layers.

Such requirements are at least partially met by an apparatus for deforming conductors protruding from a side of a stator or a rotor of an electrical machine according to claim 1, and by a method for deforming conductors protruding from one side of a stator or a rotor of an electrical machine according to claim 14.

### DESCRIPTION OF THE DRAWINGS

Further features and advantages of the present invention will become more comprehensible from the following description of preferred embodiments thereof given by way of non-limiting examples, in which:

FIG. 1 diagrammatically shows a perspective view of a preformed flattened U-shaped hairpin according to the prior art;

FIG. 2 diagrammatically shows a perspective view of a hairpin according to the prior art;

FIG. 3 diagrammatically shows a perspective view of the hairpin in FIG. 2 after the twisting method on the welding side according to the prior art;

FIG. 4 diagrammatically shows an embodiment of a portion of a mechanism to a possible embodiment, in a first working condition;

FIG. 5 diagrammatically shows the mechanism in FIG. 4, in a different working condition;

FIG. 6 diagrammatically shows a perspective front view of a possible alternative embodiment of a component according to the present invention;

FIG. 7 shows a perspective view from the bottom of a possible embodiment of a component according to the present invention;

FIG. 8 diagrammatically shows a perspective front view of a possible alternative embodiment of a component according to the present invention;

FIG. 9 diagrammatically shows a perspective view from the bottom of a possible embodiment of a component according to the present invention;

FIG. 10 diagrammatically shows a perspective top view of a possible alternative embodiment of a component of an apparatus according to the present invention;

FIG. 11 diagrammatically shows a front view of a possible embodiment of a portion of an apparatus according to the present invention;

FIG. 12 diagrammatically shows the portion of the apparatus in FIG. 11 positioned with respect to a stator/rotor of an electric machine in a step of the method according to an embodiment of the present invention;

FIG. 13 diagrammatically shows a perspective bottom view of an enlarged part of a portion of the apparatus according to a possible embodiment of the present invention;

FIG. 14 diagrammatically shows a perspective view of a possible alternative embodiment of an apparatus according to the present invention;

FIGS. 15-18 diagrammatically show a section view of a possible embodiment of an apparatus according to the present invention in various operational configurations;

FIG. 19 diagrammatically shows an enlarged portion of a possible embodiment of an apparatus according to the present invention;

FIG. 20 diagrammatically shows a perspective front view of a portion of an apparatus according to an embodiment of the present invention; and

FIG. 21 diagrammatically shows a section view of a portion of an apparatus according to an embodiment of the present invention in a possible mode of use;

FIG. 22 diagrammatically shows a section view of a portion of an apparatus according to an embodiment of the present invention in a possible mode of use; and

FIG. 23 diagrammatically shows a top plan view of a component of an apparatus according to an embodiment of the present invention.

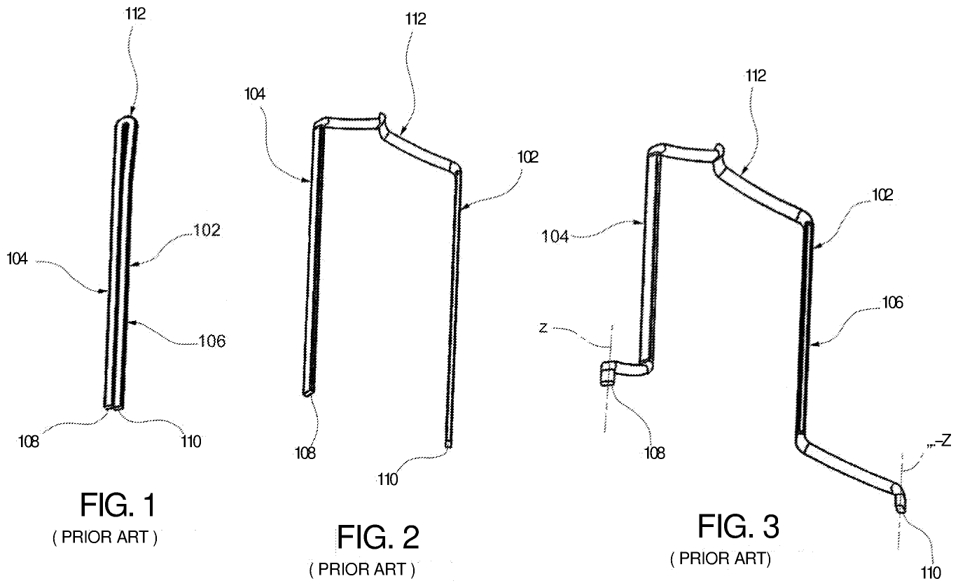

Elements or parts in common to the embodiments described will be indicated hereafter using the same reference numerals.

### DETAILED DESCRIPTION

FIG. 15 shows an apparatus, indicated by reference numeral 200, for deforming conductors 102 of at least one winding assembly 100, protruding from a side of a stator or a rotor 114 of an electric machine.

The at least one winding assembly 100 comprises a plurality of base conductors 102 comprising at least one leg 104, 106 inserted into cavities 115 of stator or rotor 114, each having at least one respective free end 108, 110.

The apparatus 200 comprises at least one twisting matrix 201 adapted to rotate about an axis X, comprising at least one pocket 204 which is suitable for the insertion of a free end 108, 110.

Furthermore, the apparatus 200 comprises a radial backing member 300 arranged close to the at least one twisting matrix 201, and in particular close to the at least one pocket 204, on the insertion side of said free end 108, 110. The radial backing member 300 comprises an inner radial backing surface 302 for a portion of leg 104, 106 protruding from said side of said stator or rotor 114 of an electric machine.

In particular, the inner radial backing surface 302 may be arranged between the axis X of the twisting matrix 201 and the leg portion 104, 106 on which it acts.

During the twisting steps, the protruding conductors 102 on the same side are bent towards each other to form the coils of a winding. At this step, the radial backing member 300 acts as an internal backing surface for the portion of the conductor leg 104, 106 which remains outside the twisting pocket and in particular the portion of the conductor between the pocket and the stator or rotor.

For example, if the twisting involves two concentric and adjacent layers at the same time, bending them in opposite tangential directions, it is preferable that the conductors subjected to twisting, seen from the axis X and according to a plane perpendicular to the axis x, are arranged along a circumference or along a spiral, which starts from the occupied in-groove position and broadens towards the position occupied by the free end 108 or 110, without creating undesirable bends, e.g., towards the inside of the winding.

For this reason, the conductors of the same layer, in their remaining portions outside the twisting pockets 204, find in the radial backing member 300 a reaction to the deformation operated by the pockets 204 themselves. Such a contrast action may allow, for example, taking the conductor to plastic deformation, at the bending points, and reduce the head height accordingly, as will be described later.

According to a possible embodiment, the radial backing member 300 may rotate about the axis X. Advantageously, the radial backing member 300 may rotate synchronously with respect to the twisting matrix 201.

Thereby, the radial backing member 300 can follow the leg portion 104, 106 during the twisting, with no sliding between the surface of the conductor 102 and the surface of the radial backing member 300.

According to a possible alternative embodiment, the radial backing member 300 may rotate at a different speed from the at least one twisting matrix 201.

However, the surface of radial backing member 300 intended to come into contact with the conductors may have a surface treatment such as to minimize the stresses on the insulating coating of the conductors in contact therewith. More in detail, possible examples of surface treatments can be thorough polishing, anti-friction treatments and treatments with special surface finishes.

According to a possible embodiment, the inner radial backing surface 302 may have a cylindrical extension with respect to the axis X. In other words, the inner radial backing surface 302, which in use is in contact with a portion of a leg 104, 106 protruding from a side of a stator or rotor (114) of an electrical machine, may be substantially parallel to axis X.

In a possible alternative embodiment, the inner radial backing surface 302 may have a conical extension. In other words, in this case, the inner radial backing surface 302 which in use is intended to come into contact with a portion of the leg 104, 106 is inclined so that it widens toward the twisting matrix 201 and narrows towards the stator or rotor.

In a possible further embodiment, the inner radial backing surface may have a conical extension. In other words, the section trace of such a surface obtained with a longitudinal plane can have a predetermined external curvature.

In this disclosure, “extension” of the inner radial backing surface 302 means the trace of the section according to a plane comprising the axis x, of the backing surface which acts on the leg portion 104, 106.

The inner radial backing surface 302 may have a continuous extension along the entire peripheral circumference of the radial backing member 300.

Alternatively, as seen in the example shown in FIG. 23, the radial backing member 300 may comprise a body 304 and a plurality of teeth 306 protruding from the body 304, such that a radial backing surface 302 is arranged on the teeth 306.

A groove may be provided between each tooth. In this case, each tooth 306 protrudes between two grooves 308.

In a possible embodiment, the teeth 306 may be fixed with respect to the body, thus making a whole, for example.

According to a possible alternative embodiment, the radial backing member 300 may comprise at least one tooth 306 which is movable in a radial direction with respect to the axis X through moving means 310. The radial backing surface 302 is provided on said at least one tooth 306.

In this case, the at least one tooth 306 is movable between a retracted position which defines a minimum radial dimension, and an extracted position defining a maximum radial dimension.

According to a possible embodiment, the at least one tooth 306 moves within a respective radial seat 312 obtained in the body 304.

According to a possible embodiment, the moving means 310 can be of cam type. In particular, the moving means 310 may exploit the rotation or the movement of a control sleeve 314 along the axis x.

According to a possible embodiment, the moving means 310 may comprise:
a first plate 316, laying perpendicular to the axis x, provided with at least one radial seat 312 for said at least one radially movable tooth 306, adapted to constrain, at least partially, the axial and circumferential movements with respect to the first plate 316 itself;
a second plate 318, lying perpendicular to the axis x, which, by moving in a relative manner to the first plate 316, causes the radial movement of the at least one tooth 306.

In this disclosure, the term “flat” used to indicate an element, means an element which extends with two main dimensions with respect to the third one, having a preferably circular peripheral footprint, which can also consist of a plurality of elements.

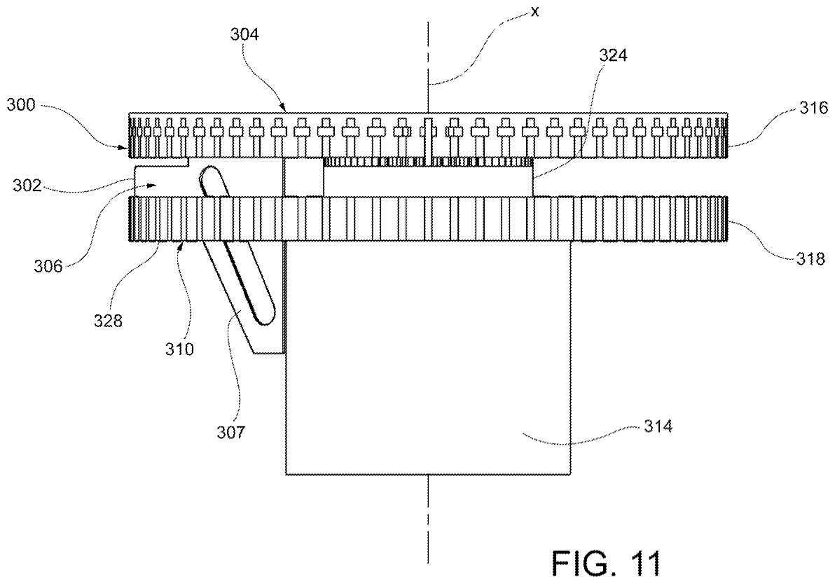

FIG. 11 shows a possible embodiment of the moving means 310 which comprises a first plate 316 and a second plate 318.

According to a possible embodiment, the moving means 310 may comprise a horizontal cam system.

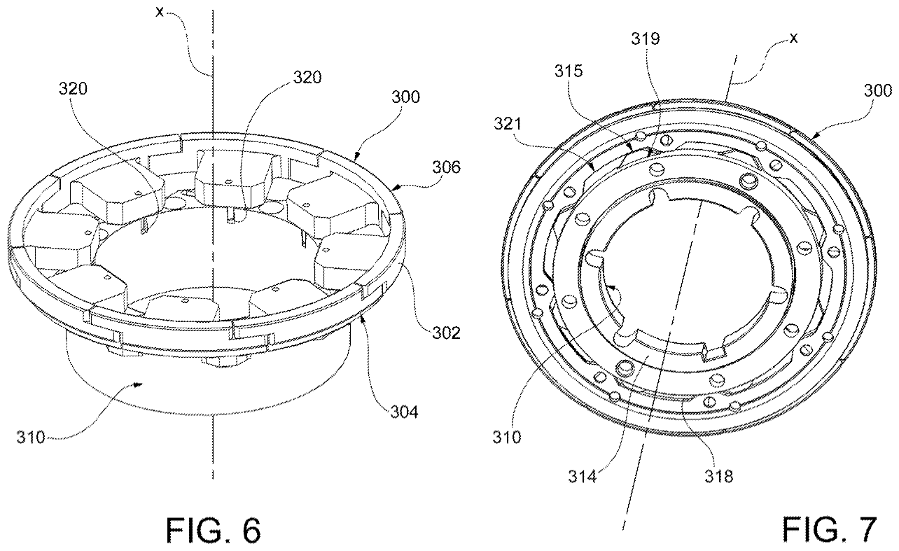

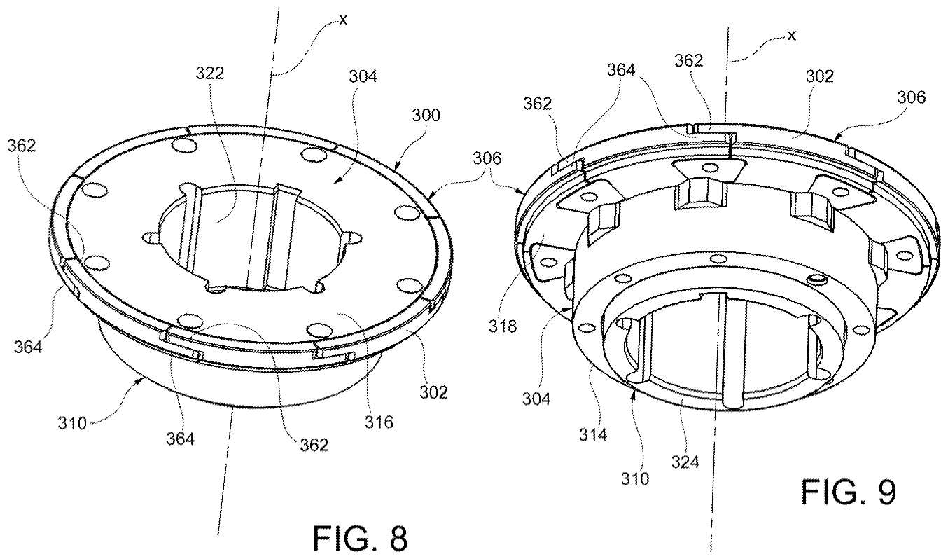

An embodiment is shown, for example, in FIGS. 6-10.

The horizontal cam-driven moving means 310 may comprise:
a first plate 316, laying perpendicular to the axis x, provided with at least one radial seat 312 for said at least one radially movable tooth 306, adapted to constrain, at least partially, the axial and circumferential movements with respect to the first plate 316 itself;
a second plate 318, lying perpendicular to the axis x, which, by moving in a relative manner to the first plate 316, causes the radial movement of the at least one tooth 306;
a slot 320 extending in a plane perpendicular to the axis x for each tooth 306, arranged on the second plate 318;
at least one pin 322, having an extension substantially parallel to the axis x, provided at one end of each tooth 306, which in use faces the second plate 318, such a pin 322 being adapted to slide and be guided by the respective horizontal slot 320. Said pins have a direction parallel to the axis x of the apparatus.

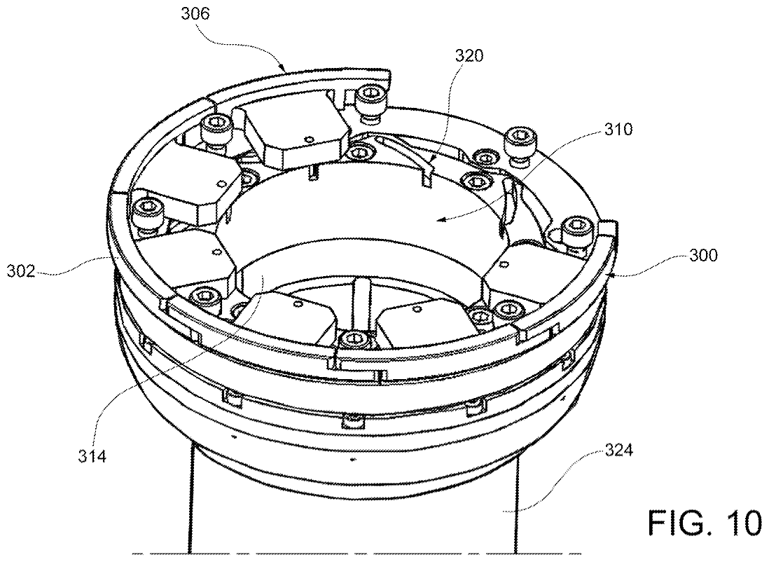

As shown in FIG. 10, each slot 320 may advantageously have a curved extension.

In this embodiment, the first plate 316 and the second plate 318 are connected to a first sleeve 324 and a second control sleeve 314, respectively.

According to a possible embodiment, said horizontal cam moving means 310 may comprise a limit stop 315. The limit stop 315 may comprise at least one radial protrusion 319 provided on the side surface of the first plate 316, and at least one corresponding sliding seat 321 arranged at the second plate 318.

An embodiment of this type is shown in FIG. 7.

According to a possible embodiment, the limit stop 315 may comprise eight radial protrusions 319 and corresponding eight sliding seats 321.

The radial protrusion 319, in a transverse plane, may be substantially trapezoidal in shape, as is the corresponding sliding seat 321, so that at the limit stop, there is the engagement of the respective oblique sides.

Since the at least one tooth 306 is within a respective radial seat (not shown in the accompanying figures) arranged on the first plate 316, a relative rotation between first sleeve 324 and control sleeve 314 causes the at least one pin 322 arranged on the at least one tooth 306 to slide, so that the tooth 306 can move radially outwards or inwards according to the direction of rotation.

According to a possible alternative embodiment, the moving means 310 may comprise a vertical cam system.

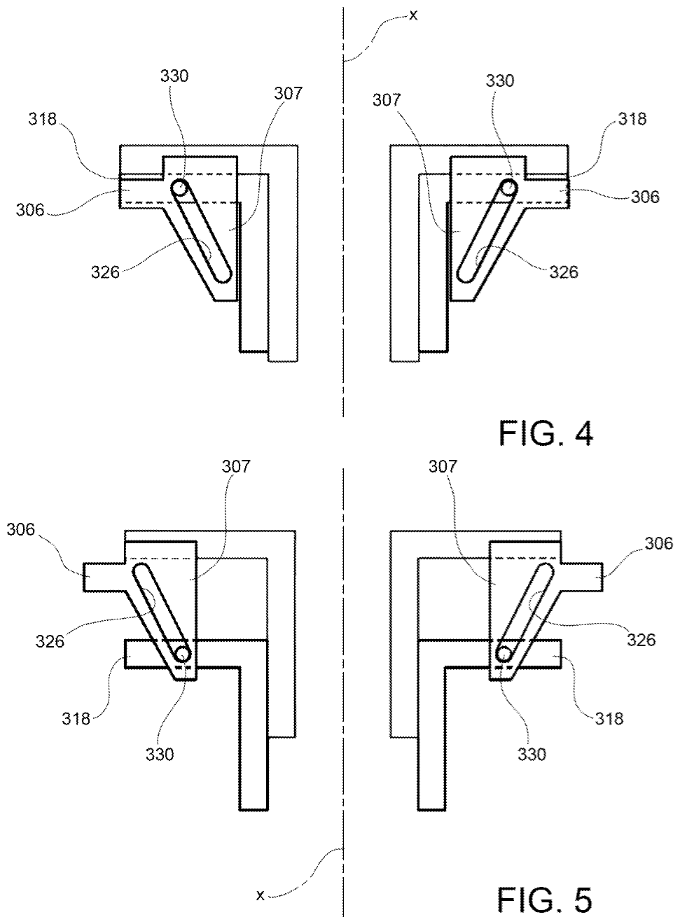

An embodiment of this type is shown, for example, in FIGS. 11-13, and diagrammatically in FIGS. 4-5.

The vertical cam moving means 310 may comprise;
a first plate 316, laying perpendicular to the axis x, provided with at least one radial seat 312 for said at least one radially movable tooth 306, adapted to constrain, at least partially, the axial and circumferential movements with respect to the first plate 316 itself;
a second plate 318, lying perpendicular to the axis x, which, by moving in a relative manner to the first plate 316, determines the radial movement of the at least one tooth 306, the plate is further provided with radial grooves 328 corresponding to each tooth 306, in which each tooth 306 is partially inserted with a support portion 307 thereof;
a vertical slot 326 provided on each support portion 307 of each tooth 306, inclined with respect to the axis x; and
at least one horizontal pin 330 extending substantially perpendicular to the axis x and provided inside the corresponding radial groove 328 crossing it perpendicularly to the radial direction and adapted to slide inside the vertical slot 326.

Again in this embodiment, the first plate 316 and the second plate 318 are connected to a first sleeve 324 and a control sleeve 314, respectively.

Since the at least one tooth 306 is within a respective radial seat 312 arranged on the first plate 316, a relative rotation between first sleeve 324 and control sleeve 314 causes the sliding of the at least one pin 330 arranged on the at least one radial groove 328, so that the tooth 306 can move radially outwards or inwards according to the relative direction translation.

As seen, for example, in FIG. 11, the vertical slot 326 can be tilted with respect to the axis x to have a greater distance from the axis x close to the first plate 316, and a smaller distance from the axis x close to the second plate 318. An embodiment of this type is diagrammatically shown in FIGS. 4 and 5.

In this case, by moving the first plate 316 towards the second plate 318, the at least one tooth falls within the first plate 316. Instead, by moving the first plate 316 away from the second plate 318, the at least one tooth comes out, toward the extracted position.

This embodiment is only an example because the embodiments of the vertical cam could also be different. For example, the vertical slot 326 can be opposite, i.e. the vertical slot 326 may be inclined with respect to the axis x to have a smaller distance from the axis x close to the first plate 316, and a greater distance from the axis x close to the second plate 318.

In this case, by moving the first plate 316 away from the second plate 318, the at least one tooth falls within the first plate 316. Instead, by moving the first plate 316 towards the second plate 318, the at least one tooth comes out, toward the extracted position.

According to a possible alternative embodiment, not shown in the accompanying figures, the second plate 318 or tappet support element may consist of several equal parts arranged in a radial pattern, each supporting said one or more pins driving the tooth 306. For example, the parts can be connected/supported by a unique structure (plate, sleeve, etc.).

According to a possible embodiment, the annular surfaces of the sleeves 314 and 324 can be provided with teeth for driving the circular movement of the sleeves.

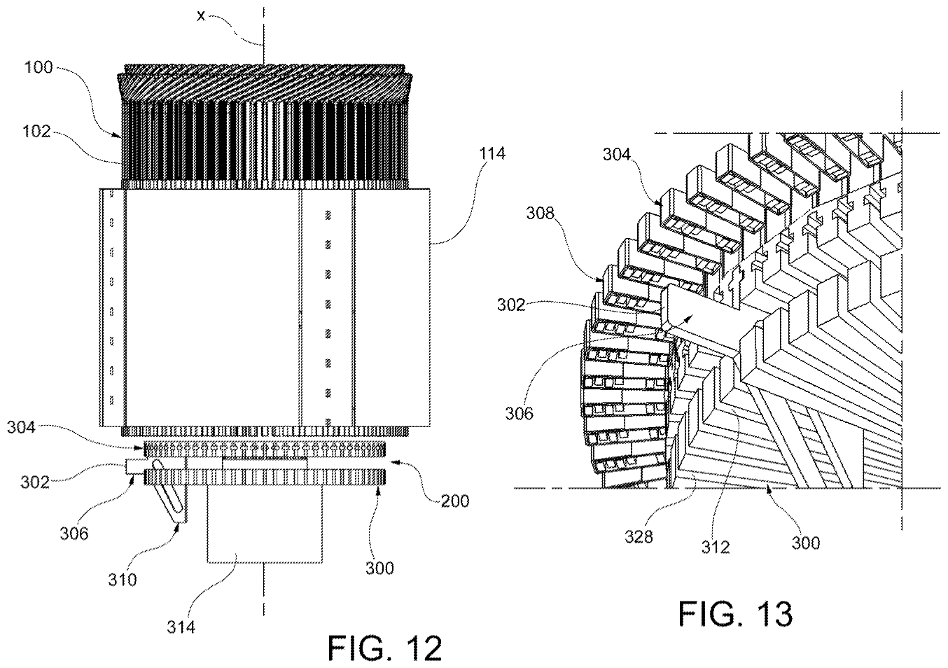

FIG. 12 shows an apparatus according to the present invention, in which the radial backing member 300 is located close to the winding assembly 100 on which it is to act. In the images, the winding sets 100 are partially inserted into the cavities 115 of the stator 114 and do not fully emerge from the twisting side of the stator core. In this case, the teeth 306 of the radial backing member 300 must be in a retracted position, or angularly offset from the grooves 115 to clear the space for the full insertion of at least one winding set 100.

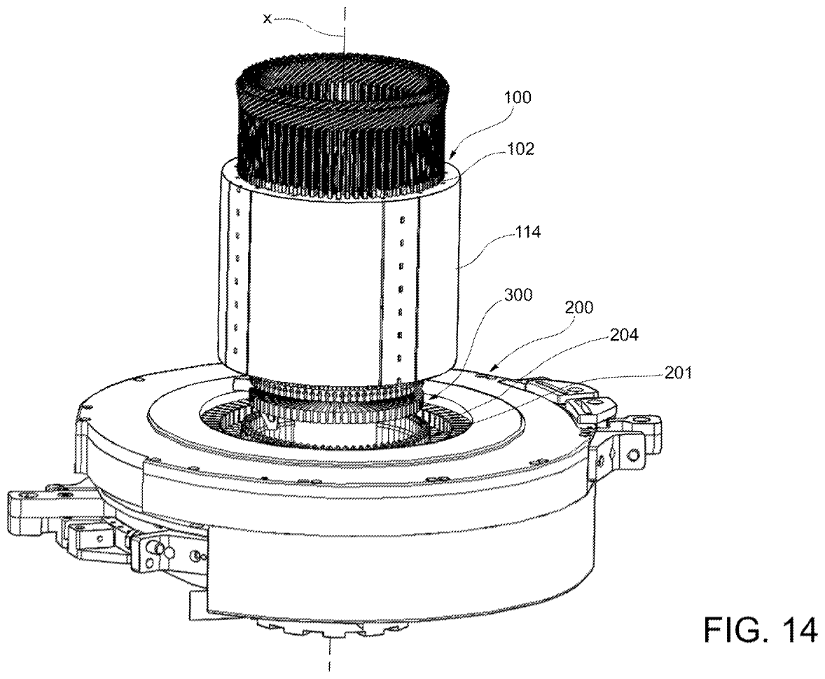

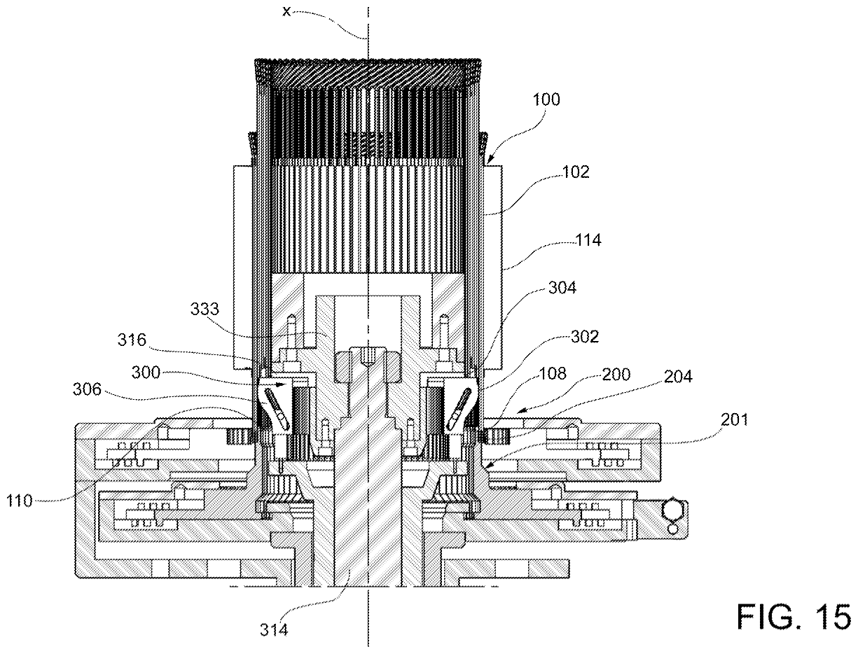

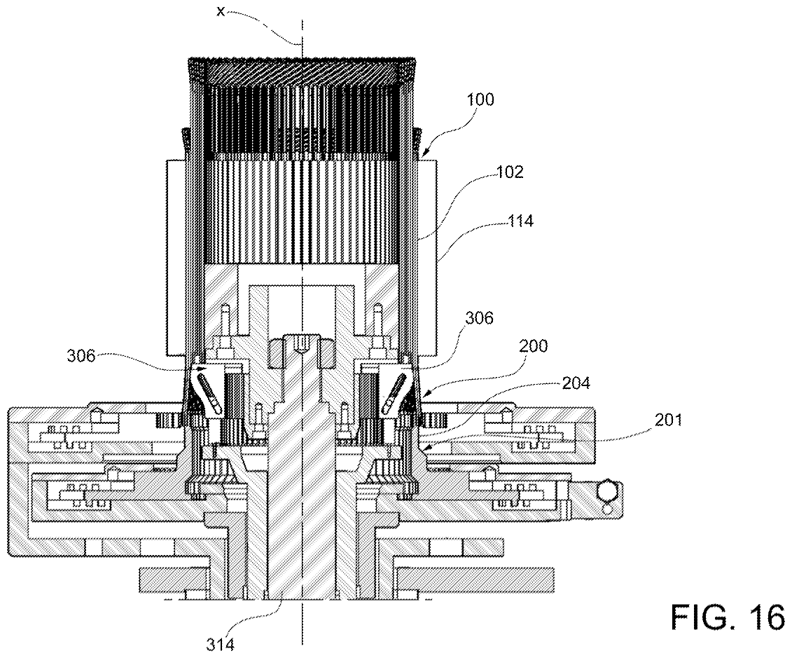

FIGS. 13-17 show an example in which the apparatus 200 comprises a twisting matrix 201 arranged with at least one pocket 204 on radially movable elements 203. In the particular embodiment shown, all pockets 204 are arranged on radially movable elements 203.

With reference to the embodiment shown in FIG. 15, the first plate 316 may be integral with the stator 114 by means of the support structure 333 of the stator 114.

In alternative embodiments, not shown in the accompanying figures, the first plate may be movable in the direction of axis X, realizing a movement along the axis X of the radial backing member 300.

In FIG. 15, it is worth noting that the outer set 100 was inserted up to the insertion of the free ends 108, 110 into the pockets 204 of the twisting matrix 201, and the teeth 306 of the radial backing member 300 were taken close to the protruding portions of the conductors 102.

FIG. 16 shows a moment after that shown in FIG. 15. In this case, the twisting has begun and the teeth 306 are acting accordingly, in reaction to the forces applied by the conductors in contact with the teeth. More in detail, the teeth 306, compared to the previous situation, shifted outwards because the pocket elements 204 of the twisting matrix 201 shifted outwards.

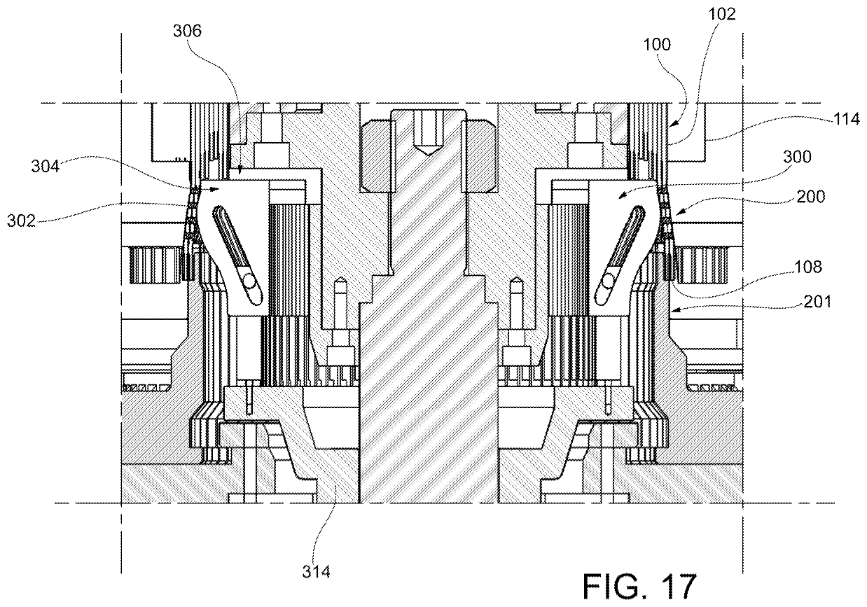

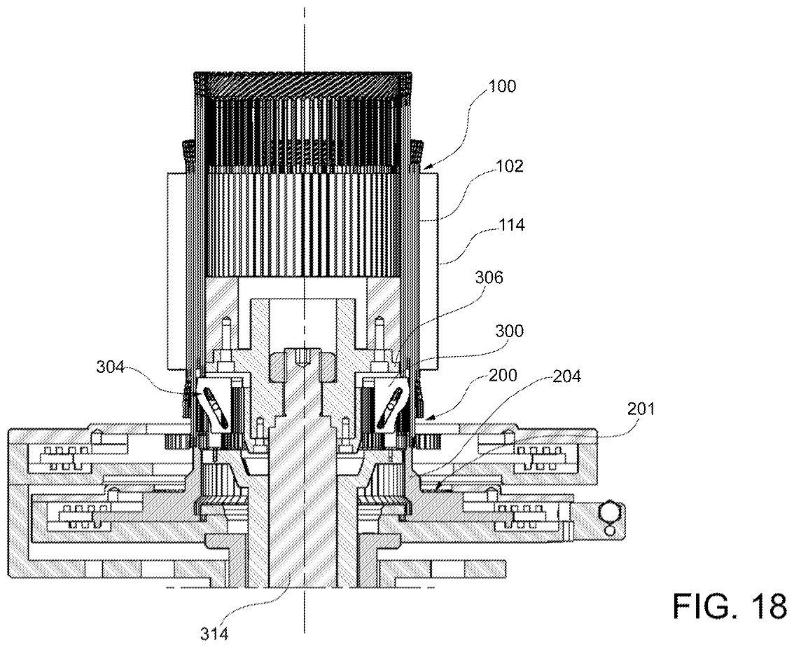

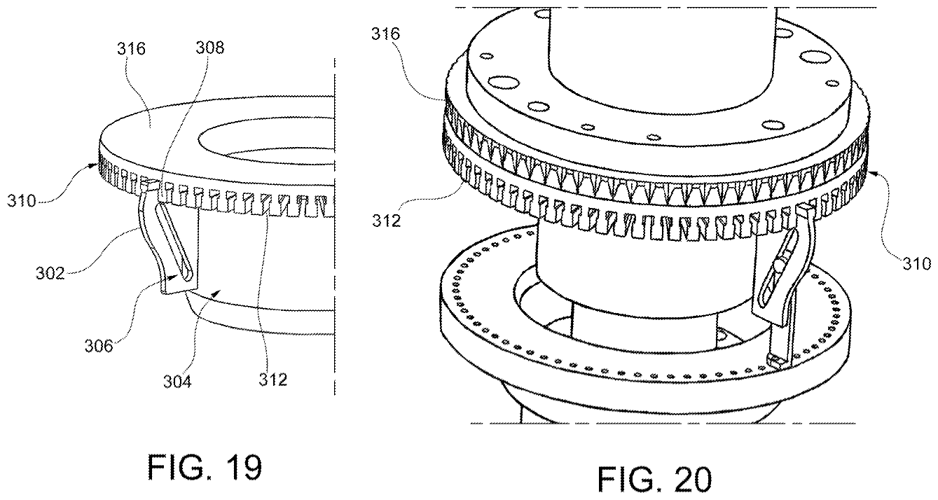

FIG. 17 shows a detail in which the teeth 306 further follow the outward movements of the conductors.

It is worth noting that the conductors of the innermost sets are prevented from sliding vertically by the teeth themselves.

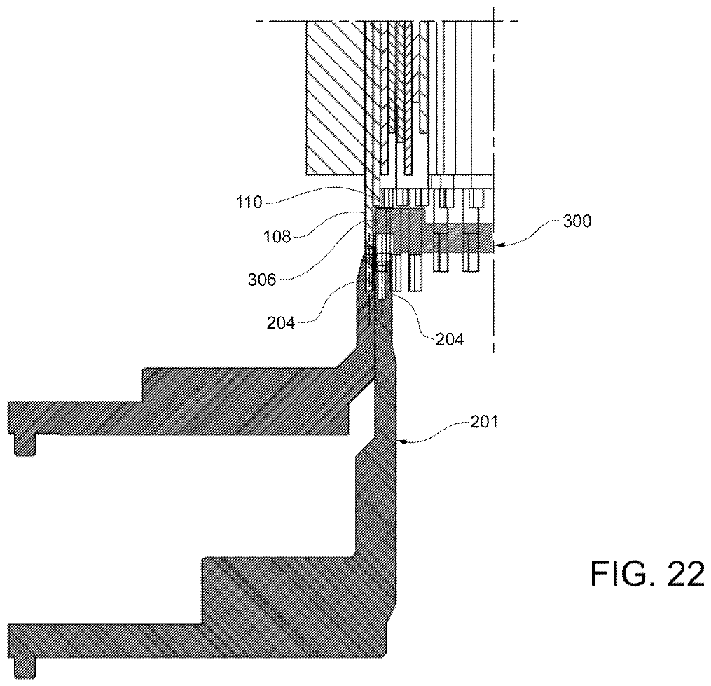

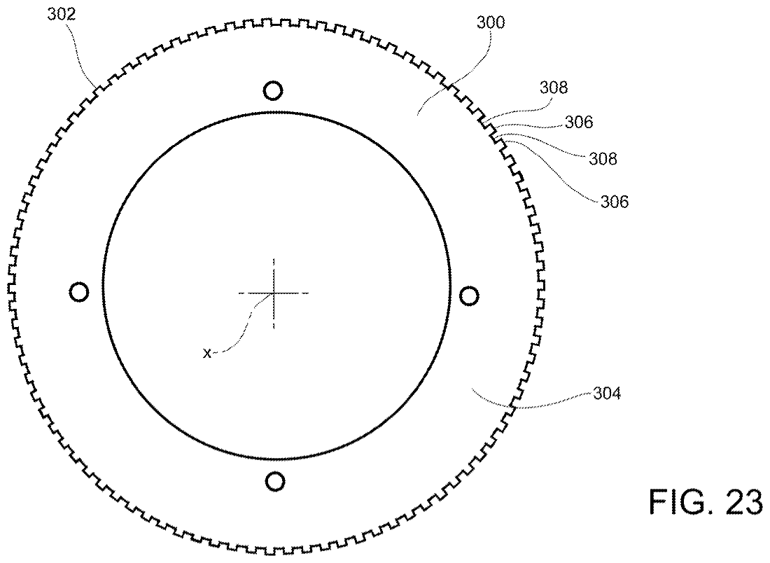

The same operational mode is also shown in FIG. 22.

In other words, according to a possible embodiment, the radial backing member 300 may be used to prevent a given set of conductors from running vertically.

According to a possible embodiment, the radial backing member 300 may be used as a guide during the insertion of the conductors into the pockets of the twisting matrix.

Indeed, FIG. 22 shows the position of the radial backing member at the end of the insertion of some conductors of an outermost layer into their respective pockets of the twisting matrix. Substantially, the entry of conductors into pockets is facilitated by the fact that the radial backing member guides the conductor so that it cannot move radially inwards.

According to a possible embodiment, the pushing of the conductors can then resume from the insertion side to determine the complete emerging from the twisting side. The pockets can accompany such a movement, while the radial backing member can remain stationary to prevent the dragging by the friction of the conductors of the innermost sets. In other words, the radial backing member can also act as an axial backing for the sets of innermost conductors as they emerge from the twisting side of a stator or rotor of an electrical machine.

FIG. 18 shows an even later instant in which the twisting of the outermost set 100 is completed and the set adjacent thereto has been inserted into the pocket elements of the twisting matrix.

According to a possible alternative embodiment, the radial backing member 300 may comprise a plurality of radially movable teeth 306 having circumferential ends 362, 364 which overlap corresponding circumferential ends 362, 364 of adjacent teeth 306 according to a direction parallel to said axis X.

In other words, each tooth 306 comprises circumferential ends 362, 364 which protrude from the tooth 306 according to positions spaced out along the axis x. Furthermore, the thickness of each circumferential end 362, 364 may be substantially half the thickness of the tooth 306. Thereby, two contiguous teeth can mate with each other because the circumferential ends are opposite, and together they substantially make the same tooth thickness.

More in detail, the number of teeth 306 may be less than the number of stator grooves to be processed. This embodiment applies, for example, to cases in which each tooth 306 may be used for contrasting the simultaneous deformation of multiple protruding conductors of the same layer.

The embodiment at issue, as compared to that previously described, has the advantage of greater compactness, resulting from the lower number of teeth 306 to be moved and thus of a relative simplicity also of the moving means 310, the number of stator grooves to be processed being equal.

As seen in FIGS. 6-10, there is a substantial overlap of the circumferential ends 362, 364, such to be able to maintain a given continuity in the radial dimension of the radial backing member 300. The overlap, in some cases, allows the contrasting action on the conductors between one tooth and the next to be maintained and the rotational movement of the teeth 306 to be omitted. Indeed, in the absence of such an overlap, with the expansion of the teeth, a groove would be created between one tooth and the other, which in the same cases causes unwanted deformations on the corresponding conductors. Therefore, in the absence of such an overlap, the radial backing member must be rotated to prevent the twisted conductors from occupying the spaces between elements.

The operation of the apparatus is apparent in light of the description of the apparatus just provided.

A possible mode of operation will be described below; however, such a mode of operation should not be understood as limiting relative to the present invention because other modes of operation are clearly possible.

Once the conductors have been threaded into the stator core, the insertion of the outermost set is completed, so that the protruding portions of the conductors of the winding set have the appropriate length to allow the free ends to be welded to be brought together. In this step, the conductors of the winding set cross with an axial movement the grooves created by the protrusions/teeth of the radial backing member, occupying them.

The ends of the conductors are inserted into respective pockets of twisting matrixes and bent radially by a twisting matrix so that they collectively define a conical surface.

In this step, the conductor portions which occupy the grooves of the radial backing member emerge therefrom. Once said portions have emerged from the grooves, the radial backing member is free to rotate.

At the end of the complete radial emerging of the portions from the grooves of the radial backing member, the radial backing member is rotated with respect to the apparatus axis X, preferably by half a groove pitch, without contacting the winding set conductors, so that the portions of the conductors are at an angular position coincident with that of the radial backing member teeth.

The function of the teeth is to provide a contrasting action during the subsequent step of twisting, carried out on a circumference with a larger diameter than that in which the same conductors are in-groove positioned. The function of the grooves is to prevent the obstruction by the backing device upon the emerging of the conductors on the welding side of the stator pack during the completion of axial insertion of the conductors into the grooves.

The free ends of the conductors of the winding set are brought closer to the axis X of the apparatus, through the twisting matrix, so that some of said portions of the conductors contact the teeth of the radial backing member.

If the radial backing member has radially movable teeth, then this step can be replaced with a step of repositioning the teeth so that they come into contact with the portions of the conductors.

At this point, the step of rotation of the pocket elements of the twisting matrix begins with the consequent deformation of the conductors of the winding set concerned by the grip, during which the radial backing member rotates with appropriate angular speed, to avoid the partial entry of the conductors into the grooves of the radial backing member.

In this disclosure, “gripping” by the pocket elements of the twisting matrix means inserting the end of the conductor into the pocket or groove without necessarily intending an actual clamping of the conductor within the pocket or groove of the twisting matrix.

The rotation of the backing device is thus associated with the presence of the grooves of the radial backing member and is necessary to prevent conductors from returning to occupy even partially the groove region of the radial backing member, risking significant stresses to the insulating coating.

When the conductors are sufficiently inclined, with respect to the insertion face of the stator core, that they cannot enter the grooves of the radial backing member, it can stop rotating.

After bending the conductors of said winding set, if the winding consists of several sets, the radial backing member must change its geometry or must be replaced with another similar one but of appropriate size, to adapt to the twisting of the next winding set, i.e. the adjacent set inwards.

The radial backing member surface connecting multiple contact/contrast areas with respective conductors subjected to the twisting action may be free of radially movable parts (teeth) and grooves, if the radial widening of the conductors themselves is not required.

The radial backing member can perform an optional function of preventing the conductors not yet twisted from emerging from the stator pack, on the welding side. When the radial backing member has a varying geometry, so that it can be used with several winding sets, subjected to non-simultaneous twisting actions, its function of obstruction against the emerging of the inner sets can be performed by a plate, also of varying geometry, axially bound to the radial backing member and free to rotate with respect thereto.

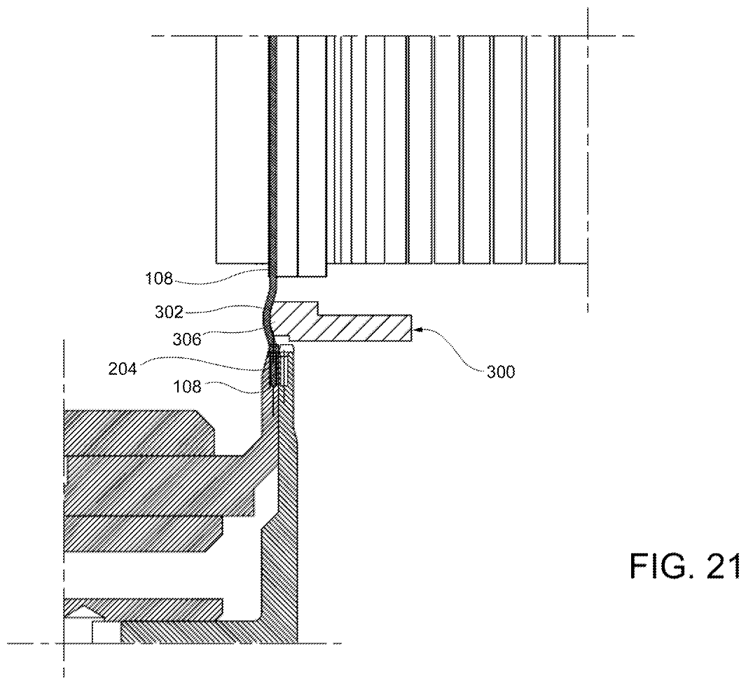

A further mode of using a radial backing member according to the present invention is diagrammatically shown in FIG. 21. Indeed, according to a possible mode of operation, the radial backing member can be used to shape and deform the portion of the conductor between the stator or rotor of the electrical machine and the twisting matrix.

For example, after the insertion into the pocket of conductor ends, an outward radial movement of the contrast teeth may occur to push the portion of conductor between the pocket of the twisting matrix and the stator or rotor of the electrical machine outwards. Preferably, the radial pushing action by the radial backing member may be accompanied by an axial approach movement between the twisting matrix and stator or rotor.

In other words, the step of backing may radially spread the free ends 108, 110 of a circular array when a portion of said free ends 108, 110 is inserted into pockets 204 of a twisting array 108, 110, said pockets having substantially fixed radial distance from the axis x.

Such an approach can have a dual purpose; e.g., it can prevent the end of the conductor from exiting the respective pocket, or it can also contribute to the deformation of the conductor portion.

Some of the steps in which the radial backing member apparatus according to the present invention may be used are described below:
partial insertion of conductors into the grooves of the stator core;
completion of axial insertion of one or more winding sets into the twist pockets;
positioning of the radial backing member in an appropriate position to complete insertion of the conductors into the grooves of the stator core, so as not to obstruct complete emerging on the welding side;
radial spreading of the protruding conductors on the welding side, so that they are arranged outside a conical geometry;
positioning of the radial backing member close to respective portions of conductors protruding on the welding side, by rotation of the teeth and/or axial positioning of the teeth, with respect to the winding;
recovery of the distance between radial backing member and conductors due to: tooth rotation, radial tooth movement, axial tooth positioning;
execution of the action as in the previous case until the conductors come into contact with the backing member elements;
radial backing member positioning until contact with the conductors, through a rotation of the teeth, radial movement of the teeth, axial positioning of the teeth;
twisting with the possibility of simultaneous or sequential action of radial spreading;
tracking of conductors by the radial backing member, achieved by compositing the radial, angular, and axial motion trajectories to shape the protruding portions of conductors so that they lie outside a truncated cone or cylindrical region and to minimize the slip of each conductor on the surface of the respective radial backing member;
end of the twisting or the twisting with previous/simultaneous/subsequent radial spreading of a winding set or a group of winding sets;
relative departure of the radial backing member from the respective constrained or unconstrained portions of the conductor in the pockets;
change of contrast device or change in its geometry;
repetition of the steps already performed for several winding sets.

The advantages of an apparatus and method according to the present invention are thus now apparent.

In particular, it is convenient to use a radial backing member according to the present invention, because it acts with an exiting radial force with respect to the axis X of the twisting apparatus, on a portion of the conductor leg not engaged by the gripping element.

Thereby, that part of the conductor leg can be kept outside a predetermined radial distance from the axis X.

Furthermore, the use of radial backing member allows minimizing the mechanical stresses on the coating of the conductors subjected to some of the steps of twisting, with particular reference to the mutual actions between conductors of a pair of adjacent layers subjected to simultaneous twisting on the welding side. Contrast/contact surfaces with the outer layer conductors can be defined at any time of the twisting on the inner layer conductors, which in turn operate a contrast action on the outer layer conductors. Such surfaces are maximized, minimizing the pressures on the insulator resulting from these actions if the inner layer conductors are kept in contact with the surface of the movable tooth contrast.

In particular, the use of radial backing member avoids that part of at least one conductor protruding from the welding side, subject to deformation of said conductors operated by a twisting matrix, as a result of the same deformation, occupies the space required for the insertion of the rotor (or stator) or the completion of the insertion of the rotor (or stator) or the completion of the insertion of winding layers placed on innermost or outermost radial positions with respect to the axis x.

Using the radial backing member is useful in minimizing stresses on the insulation of a conductor protruding from the welding side if, before bending the conductor, at least one of the conductor layers adjacent to the conductor at issue has been fully inserted to protrude from the welding side by the length required for the free ends of its conductors to approach those of the conductors in an adjacent layer.

Again, the use of a radial backing member with movable elements in the radial direction with respect to the axis X facilitates the process of bending the protruding conductors because of the problems described above and because it can accommodate the different sizes of the sets or winding layers which form a stator or rotor winding, to be bent. By virtue of the movable teeth, it is possible to use a single contrast matrix per winding, instead of one contrast matrix per set or winding layer.

In order to meet specific needs, those skilled in the art will be able to make changes to the embodiments described above or replace the elements described with equivalent elements without departing from the scope of the appended claims.

1. An apparatus for deforming conductors of at least one winding assembly, protruding from a side of a stator or rotor of an electric machine;
said at least one winding assembly comprising a plurality of conductors comprising at least one leg inserted into cavities of the stator or rotor, having at least one respective free end;
said apparatus comprising at least one twisting matrix adapted to rotate about an axis (X), comprising at least one pocket suitable for insertion of the at least one free end;
wherein said apparatus further comprises a radial backing member provided close to said at least one twisting matrix, and in particular close to said at least one pocket, on an insertion side of said at least one free end;
said radial backing member comprising an inner radial backing surface for a portion of said at least one leg protruding from said side of said stator or rotor.

2. The apparatus of claim 1, wherein said radial backing member comprises an inner radial backing surface for a portion of said at least one leg protruding from said side of said stator or rotor between said stator or rotor and said at least one pocket.

3. The apparatus of claim 1, wherein said inner radial backing surface is arranged between the axis (X) of the at least one twisting matrix and the portion of the at least one leg portion on which it acts.

4. The apparatus of claim 1, wherein said radial backing member is adapted to rotate about said axis (X) either synchronously or asynchronously with respect to said at least one twisting matrix.

5. The apparatus of claim 1, wherein said radial backing member is adapted to translate along the axis (X).

6. The apparatus of claim 1, wherein said inner radial backing surface has a substantially cylindrical extension.

7. The apparatus of claim 1, wherein said inner radial backing surface has a substantially conical extension.

8. The apparatus of claim 1, wherein said radial backing member comprises a body and a plurality of teeth protruding from said body, said inner radial backing surface being provided on said plurality of teeth.

9. The apparatus of claim 1, wherein said radial backing member comprises at least one tooth which is movable in a radial direction with respect to said axis (X) via moving means, said at least one tooth being movable between a retracted position that defines a minimum radial dimension, and an extracted position that defines a maximum radial dimension, said inner radial backing surface being provided on said at least one tooth.

10. The apparatus of claim 9, wherein said radial backing member comprises a plurality of teeth movable in the radial direction, said teeth having circumferential ends that overlap corresponding circumferential ends of adjacent teeth according to a direction parallel to said axis (X).

11. The apparatus of claim 9, wherein said moving means comprise:
a first plate laying perpendicular to the axis (X), provided with at least one radial seat for said at least one tooth movable in the radial direction, adapted to constrain, at least partially, axial and circumferential movements with respect to the first plate; and
a second plate lying perpendicular to the axis (X) which, by moving a relative to the first plate, causes a radial movement of the at least one tooth.

12. The apparatus of claim 11, wherein said moving means have horizontal cams and comprise:
a first plate laying perpendicular to the axis (X), provided with at least one radial seat for said at least one tooth movable in the radial direction, adapted to constrain, at least partially, the axial and circumferential movements with respect to the first plate;
a second plate lying perpendicular to the axis (X), which, by moving a relative to the first plate, causes the radial movement of the at least one tooth;
a horizontal slot for each tooth, provided on the second plate; and
at least one pin, having an extension substantially parallel to the axis (X), provided at one end of each tooth, which in use faces the second plate, the at least one pin being slidable and suitable for being guided by a respective horizontal slot.

13. The apparatus of claim 11, wherein said moving means have vertical cams and comprise:
a first plate laying perpendicular to the axis (X), provided with at least one radial seat for said at least one tooth movable in the radial direction, adapted to constrain, at least partially, the axial and circumferential movements with respect to the first plate;
a second plate lying perpendicular to the axis (X) which, by moving a relative to the first plate, causes the radial movement of the at least one tooth, said second plate being further provided with at least one radial groove corresponding to said at least one tooth, in which each tooth is partially inserted with a support portion thereof;
a vertical slot extending in a plane passing through the axis (X) provided on the support portion of each tooth, inclined with respect to the axis (X); and
at least one horizontal pin extending substantially perpendicular to the axis (X) and provided inside the corresponding radial groove crossing it perpendicularly to the radial direction, and adapted to slide inside the vertical slot.

14. A method for deforming conductors of at least one winding assembly, protruding from a side of a stator or rotor of an electric machine, said at least one winding assembly comprising a plurality of conductors comprising at least one leg inserted into cavities of the stator or rotor, having at least one respective free end; said method comprising:
gripping at least one free end by at least one twisting matrix adapted to rotate about an axis (X), wherein the at least one free end is inserted into a pocket of said at least one twisting matrix;
releasing the at least one free end by the at least one twisting matrix; and
a backing step wherein a radial backing member provided close to said at least one twisting matrix, and in particular close to said pocket, on an insertion side of said at least one free end into said pocket, acts as an inner radial backing element for a portion of said at least one leg protruding from said side of said stator or rotor;
wherein said baking step may take place before, after and/or even during gripping the at least one free end.

15. The method of claim 14, wherein the gripping, releasing, and backing steps simultaneously involve all leg portions protruding from said side of said stator or rotor of a circular array having the same radial position defined by pockets of said at least one twisting matrix in which free ends of said legs are inserted.

16. The method of claim 14, wherein said radial backing member comprises at least one tooth movable in a radial direction with respect to said axis (X) via moving means, an inner radial backing surface for a portion of said at least one leg projecting from said side of said stator or rotor being provided on said at least one tooth, said at least one tooth being movable between a retracted position that defines a minimum radial dimension, and an extracted position that defines a maximum radial dimension; said method further comprising radially moving said at least one tooth.

17. The method of claim 16, wherein during said backing step, said at least one tooth of said radial backing member is moved radially between the retracted position and the extracted position, simultaneously with a twisting step.

18. The method of claim 17, wherein said twisting step comprises a step in which at least one pocket is moved radially.

19. The method of claim 18, further comprising a backing step in which said radial backing member during the twisting step rotates with respect to the axis (X) and/or translates along the axis (X).

20. The method of claim 19, wherein said backing step simultaneously involves all leg portions protruding from said side of said stator or rotor of a circular array having the same radial position defined by pockets of said at least one twisting matrix in which free ends of said legs are inserted.

21. The method of claim 20, wherein said backing step comprises radially expanding the leg portions of the circular array when the free ends thereof are inserted into the pockets of said at least one twisting matrix.
